(19) United States
(12) Patent Application Publication
(10) Pub. No.: US 2009/0106366 A1
(43) Pub. Date: Apr. 23, 2009

(54) SYSTEM AND METHOD FOR VISUALIZING THREADED COMMUNICATION ACROSS MULTIPLE COMMUNICATION CHANNELS USING A MOBILE WEB SERVER

(75) Inventors: Jyri Virtanen, Helsinki (FI); James Reilly, Helsinki (FI); Mikko Tarkiainen, Espoo (FI)

Correspondence Address: MORGAN & FINNEGAN, L.L.P., 3 WORLD FINANCIAL CENTER, NEW YORK, NY, 10281-2101, US

(73) Assignee: NOKIA CORPORATION, Espoo (FI)

(21) Appl. No.: 11/873,939

(22) Filed: Oct. 17, 2007

(51) Int. Cl. G06F 15/16

(52) U.S. Cl. 709/206

(57) ABSTRACT

A system, apparatus and method for visualizing threaded communication across multiple communication channels using a Mobile Web Server. A Mobile Web Server enables access to the messages received on a wireless communication device from the Internet using any web browser. Messages belonging to the same conversation, even if received on multiple communication channels (SMS, MMS, email, IM, Bluetooth, etc.), may be displayed in a threaded fashion. Once displayed on the web browser, a user may then view, create, edit, send, receive and filter the messages according to sender, receiver, time ranges, keyword/content, etc. A user does not have to be in physical possession of his or her wireless communication device to access received messages. Rather, one advantage of the invention is to allow a user to access messages on the wireless communication device where the user has forgotten the wireless communication device or spends most of his or her time in front of a personal computer in a location remote from the wireless communication device.

### BACKGROUND OF THE INVENTION

1. Field of Invention

The present invention relates to a system for viewing messages received on a wireless communication device, and more specifically, to viewing messages received on a wireless communication device via one or more communication channels using a web browser.

2. Background

Wireless communication devices are becoming the mainstay of personal communication. In addition to asynchronous voice communication, wireless communication devices may be used for sending and receiving messages on various communication channels such as email, SMS, MMS, IM, Bluetooth™ or the like.

Certain messaging methods, like SMS, may be particularly suitable for small-screen portable devices. However, for other types of messaging like email, the somewhat limited user interface and memory capacity of simple wireless communication devices like mobile phones may offer somewhat limited usability when compared to the resources offered by devices such as desktop computers, laptop computers, Internet tablets or even emerging multifunction wireless devices. Limited access to messaging may be convenient (e.g., just to read an email) when typically performed using the limited user interface of mobile phones. However, when required to perform longer tasks with e-mail and other messaging methods, many users tend to prefer the superior user interface and memory of desktop or laptop PCs.

Further, even though a user may send and receive messages via a multitude of communication channels as discussed above, the user cannot view messages sent over different communication channels in a unified way. The utilization of separate messaging clients may be required to view and send different types of messages (SMS, MMS, email, IM, Bluetooth™, etc.). For example, if a user is reading an email message and wishes to reply to the email message using a text message, the user must exit the email program and navigate using menu options to activate a text messaging application to send the text message. Further, the user will not be able to view the conversation (e.g., the original email and the subsequent text message replying to the email) as a single thread. This becomes especially confusing when various communication channels (e.g. SMS, MMS, email, IM, Bluetooth™, etc.) are used to discuss the same cognitive thread (e.g., over time a single conversation may take place across different communication channels). While some messaging systems such as Gmail™ and the iPhone™ are able to display conversation threads, they only display conversation threads for one communication channel at a time (SMS or email). Furthermore, it may be difficult (or even impossible) to search messages by sender, receiver, content, time, etc. which have been sent or received across multiple communication channels.

### SUMMARY OF INVENTION

In accordance with exemplary embodiments of the present invention, a system, apparatus and method for enabling access to the content of a wireless communication device (WCD), such as a mobile phone, from the Internet using a web browser on a remote terminal, such as a desktop or laptop PC, an Internet tablet or a web browser on a wireless communication device is provided. Such information may be accessible when the user is logged on to his or her wireless account over a network, such as the Internet.

In accordance with at least one exemplary embodiment of the present invention, the WCD may communicate with the PC via a Mobile Web Server on the WCD which provides access to messages which may have been received through one or more communication channels (e.g., SMS, MMS, email, IM, Bluetooth™, etc.). The Mobile Web Server may enable access to the messages such that a user may view, create, edit, send, receive and search the messages using a web browser on a desktop or laptop PC.

According to another exemplary embodiment, the Mobile Web Server may enable the viewing of messages which are part of the same conversation as a single conversational thread, even if the messages in the conversation have been received through multiple communication channels.

According to another exemplary embodiment, the Mobile Web Server may allow searching of messages according to various user-selectable criteria such as sender, receiver, time ranges, keyword, etc.

### BRIEF DESCRIPTION OF DRAWINGS

The invention will be further understood from the following detailed description of various exemplary embodiments, taken in conjunction with appended drawings, in which:

FIG. 1 discloses a structural description of an exemplary wireless communication device usable with at least one embodiment of the present invention.

FIG. 2 discloses an exemplary system according to at least one embodiment of the present invention.

FIG. 3 discloses a modular description of the exemplary wireless communication device and remote terminal previously described in FIG. 2.

FIG. 4 discloses an exemplary flow chart of one of the possible sequence of steps carried out by the remote terminal to interface with the Mobile Web Server.

It is to be understood that the drawings are designed solely for purposes of illustration and not as a definition of the limits of the invention, for which reference should be made to the appended claims.

### DETAILED DESCRIPTION

While the invention has been described in terms of exemplary embodiments, various changes can be made therein without departing from the spirit and scope of the invention, as described in the appended claims.

A WCD usable with various embodiments of the present invention may include anything from a basic mobile phone to a more complex handheld device such as a smartphone or PDA. Therefore, it may be worthwhile to understand the communication tools available to a user before exploring the features of the present invention. For example, in the case of a mobile phone or other handheld wireless device, the integrated data handling capabilities may play an important role in facilitating the transaction between the transmitting and receiving devices.

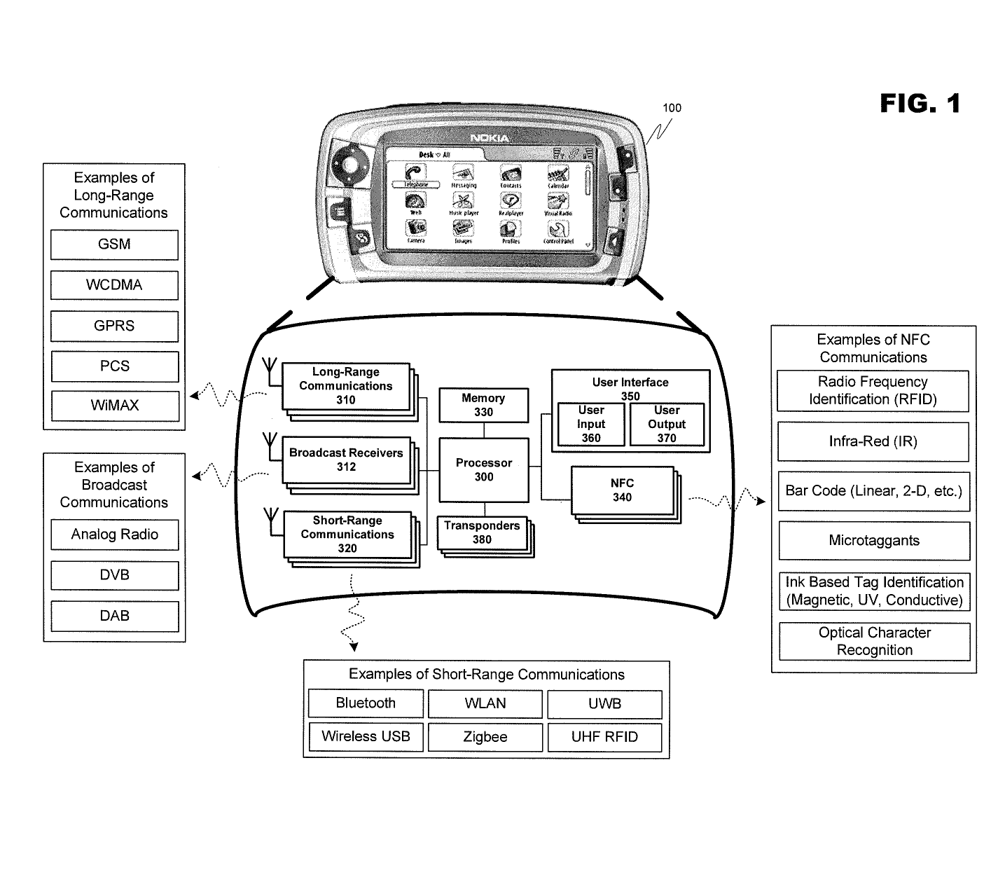

FIG. 1 discloses an exemplary structural layout of WCD 100 according to an exemplary embodiment of the present invention. Processor 300 controls overall device operation. As shown in FIG. 1, processor 300 may be coupled to at least communications sections 310, 312, 320 and 340. Processor 300 may be implemented with one or more microprocessors that are each capable of executing software instructions stored in memory 330.

Memory 330 may include random access memory (RAM), read only memory (ROM), and/or flash memory, and stores information in the form of data and software components (also referred to herein as modules). The data stored by memory 330 may be associated with particular software components. In addition, this data may be associated with databases, such as a bookmark database or a business database for scheduling, email, etc.

Memory 330 may also encompass different forms of removable media that may be accessed by resources within WCD 100. A device such as WCD 100 may be configured to accept different forms of removable media, such as flash memory, CD-ROM, DVD-ROM, etc. Once coupled to, or inserted within, WCD 100, processor 300 may trigger a read/write device to access this removable media in order to load program information and/or other forms of data into memory integrated within WCD 100.

The software components stored by memory 330 may include instructions that can be executed by processor 300. Various types of software components may be stored in memory 330. For instance, memory 330 may store software components that control the operation of communication sections 310, 312, 320 and 340. Memory 330 may also store software components including a firewall, a service guide manager, a bookmark database, user interface manager, and any communications utilities modules required to support WCD 100.

Long-range communications 310 performs functions related to the exchange of information over large geographic areas (such as cellular networks) via an antenna. These communication methods include technologies from 1G to 3G. In addition to basic voice communications (e.g., via GSM), long-range communications 310 may operate to establish data communications sessions, such as General Packet Radio Service (GPRS) sessions and/or Universal Mobile Telecommunications System (UMTS) sessions. Also, long-range communications 310 may operate to transmit and receive messages, such as short messaging service (SMS) messages, multimedia messaging service (MMS) messages, instant messages (IM) and/or email. As disclosed in FIG. 1, Long-range communications 310 may be composed of one or more subsystems supporting various long-range communications mediums. These subsystems may, for example, be radio modems enabled for various types of long-range wireless communication.

As a subset of long-range communications 310, or alternatively operating as an independent module separately connected to processor 300, broadcast receivers 312 allows WCD 100 to receive transmission messages via mediums such as Analog Radio, Digital Video Broadcast for Handheld Devices (DVB-H), Digital Audio Broadcasting (DAB), etc. These transmissions may be encoded so that only certain designated receiving devices may access the transmission content, and may contain text, audio or video information. In at least one example, WCD 100 may receive these transmissions and use information contained within the transmission signal to determine if the device is permitted to view the received content. As in the case of long-range communications 310, broadcast receivers 312 may be comprised of one or more radio modems utilized to receive a variety of broadcast information.

Short-range communications 320 is responsible for functions involving the exchange of information across short-range wireless networks. As described above, examples of such short-range communications 320 are not limited to Bluetooth™, WLAN, UWB, Zigbee, UHF RFID, and Wireless USB connections. Accordingly, short-range communications 320 performs functions related to the establishment of short-range connections, as well as processing related to the transmission and reception of information via such connections. Short-range communications 320 may be composed of one or more subsystems made up of, for example, various radio modems employed to communicate via the previously indicated assortment of short range wireless mediums.

Short-range input device 340, may provide functionality related to the short-range scanning of machine-readable data (e.g., for NFC). For example, processor 300 may control short-range input device 340 to generate RF signals for activating an RFID transponder, and may in turn control the reception of signals from an RFID transponder. Other short-range scanning methods for reading machine-readable data that may be supported by the short-range input device 340 are not limited to IR communications, linear and 2-D (e.g., QR) bar code readers (including processes related to interpreting UPC labels), and optical character recognition devices for reading magnetic, UV, conductive or other types of coded data that may be provided in a tag using suitable ink. In order for the short-range input device 340 to scan the aforementioned types of machine-readable data, the input device may include a multitude of optical detectors, magnetic detectors, CCDs or other sensors known in the art for interpreting machine-readable information.

As further shown in FIG. 1, user interface 350 is also coupled to processor 300. User interface 350 facilitates the exchange of information with a user. FIG. 1 shows that user interface 350 includes a user input 360 and a user output 370. User input 360 may include one or more components that allow a user to input information. Examples of such components include keypads, touch screens, and microphones. User output 370 allows a user to receive information from the device. Thus, user output portion 370 may include various components, such as a display, light emitting diodes (LED), tactile emitters and one or more audio speakers. Exemplary displays include liquid crystal displays (LCDs), and other video displays.

WCD 100 may also include one or more transponders 380. This is essentially a passive device that may be programmed by processor 300 with information to be delivered in response to a scan from an outside source. For example, an RFID scanner mounted in an entryway may continuously emit radio frequency waves. When a person with a device containing transponder 380 walks through the door, the transponder is energized and may respond with information identifying the device, the person, etc.

Hardware corresponding to communications sections 310, 312, 320 and 340 provide for the transmission and reception of signals. Accordingly, these portions may include components (e.g., electronics) that perform functions, such as modulation, demodulation, amplification, and filtering. These portions may be locally controlled, or controlled by processor 300 in accordance with software communications components stored in memory 330.

The elements shown in FIG. 1 may be constituted and coupled according to various techniques. One such technique involves coupling separate hardware components corresponding to processor 300, communications sections 310, 312 and 320, memory 330, short-range input device 340, user interface 350, transponder 380, etc. through one or more bus interfaces. Alternatively, any and/or all of the individual components may be replaced by an integrated circuit in the form of a programmable logic device, gate array, ASIC, multi-chip module, etc. programmed to replicate the functions of the stand-alone devices. In addition, each of these components is coupled to a power source, such as a removable and/or rechargeable battery (not shown).

The user interface 350 may interact with a communications utilities software component, also contained in memory 330, which provides for the establishment of service sessions using long-range communications 310 and/or short-range communications 320. The communications utilities component may include various routines that allow the reception of services from remote devices according to mediums such as the Wireless Application Protocol (WAP), Hypertext Markup Language (HTML) variants like Compact HTML (CHTML), etc.

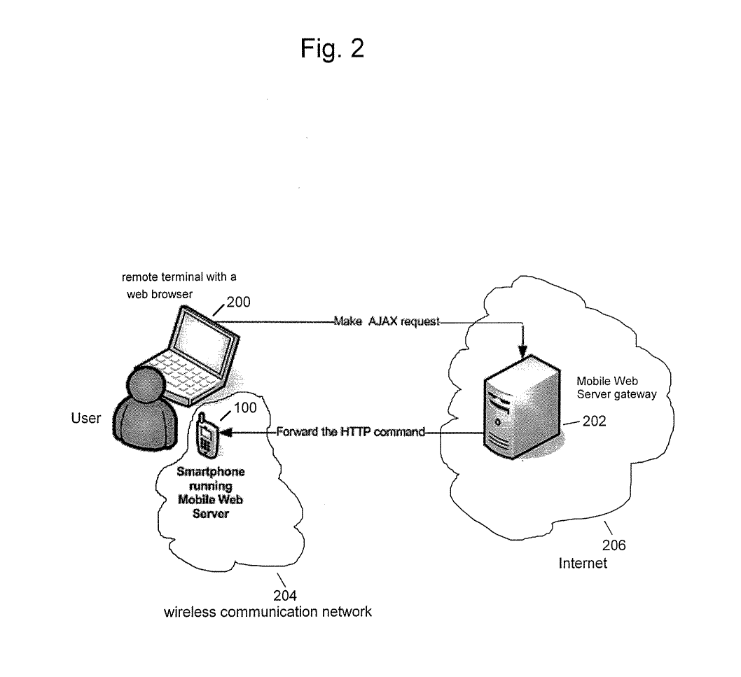

FIG. 2 is an exemplary embodiment of the present invention showing the system that enables WCD 100 to communicate with an application such as a web browser, such application being implemented in accordance with an Internet protocol, such as the HTTP, Extensible Markup Language (“XML”), or HTML protocol. The system comprises, for example, WCD 100 with at least a Mobile Web Server, a wireless communication network 204, the Internet 206, a gateway 202 and a remote terminal 200 with at least a web browser.

In FIG. 2, the Internet 206 which, for example, may be a WAN defined by the use of TCP/IP to exchange information, but alternatively may be any other type of WAN, is connected to the wireless communication network 204 through the gateway 202 which may be needed when WCD 100 resides behind a NAT/Firewall. Gateway 200 forms a connection or bridge between the WAN and the wireless communication network 204 and alternatively, may be used to form a connection or bridge between the WAN and any other type of network, such as an RF wireless network, cellular network, satellite network, or other synchronous or asynchronous land-line connection. In the absence of a NAT/Firewall, remote terminal 200 may connect directly to WCD 100 without first connecting to gateway 200. Remote terminal 200 may be connected to a landline telecommunication network PSTN by a modem (not shown), to an integrated services digital network (ISDN, not shown) by an ISDN adapter (not shown), or to a Local Area Network (“LAN”) via wired or wireless communication.

By way of example, an exemplary remote terminal 200, such as a desktop or laptop PC, Internet tablet or wireless communication device, may include at least a central processing unit (“CPU”), a system memory, and a system bus that couples various system components including the system memory to the processing unit. Remote terminal 200 may further include a hard disk drive for reading from and writing to a hard disk, a magnetic disk drive for reading from or writing to a removable magnetic disk, and an optical disk drive for reading from or writing to a removable optical disk, such as a CD-ROM or other optical media. The drives and the associated computer-readable media may provide storage for computer readable instructions, program modules, data structures and other information for use by remote terminal 200. Remote terminal 200 may operate in a wired or wireless networked environment using connections to one or more remote computers. A remote computer may be another personal computer, a server, a router or other network node, and may typically include many or all of the elements described above relative to remote terminal 200.

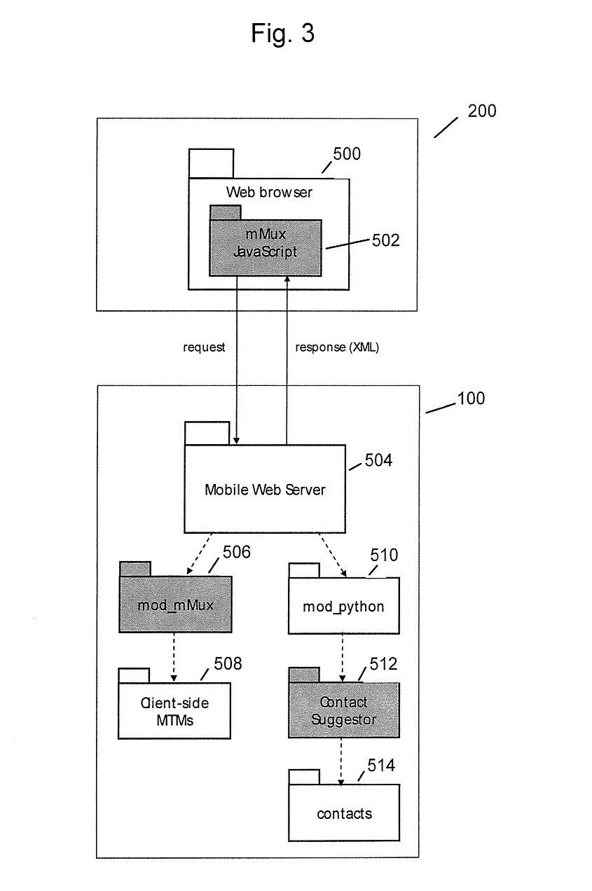

FIG. 3 is a simplified illustration, according to an exemplary embodiment of the present invention, of the various software modules that may reside on the WCD 100 and remote terminal 200. The software modules may reside in local memory, or alternatively may be provided on a CD-ROM, DVD-ROM, flash memory, etc. that may be coupled to either one or both of the WCD 100 and the remote terminal 200.

As shown in FIG. 3, remote terminal 200 may comprise a web browser 500, which may be any web browser supporting JavaScript as is well known in the art. The web browser 500 may include JavaScript 502 embedded in the initial page of mMux, which in response to user events (e.g. message filtering changes) may make requests to Mobile Web Server 504 residing on WCD 100, and may update the message view with the XML data returned as a response from Mobile Web Server 504. WCD 100 may further include at least Mobile Web Server 504, mod_mMux 506, Client-side Message Type Modules (MTMs) 508, mod_python 510, contact suggestor 512 and contacts 514. In accordance with an exemplary embodiment of the present invention, Mobile Web Server 504 may be a Symbian port of the Apache httpd web server, mod_mMux module 506 may be an Apache module which may get message data in XML format from the Symbian Messaging Framework, Client-side MTMs 508 may be components of the Symbian Messaging Framework which provide message data handling functions, mod_python module 510 may be an Apache module which may embed the Python interpreter within the Mobile Web Server 504, contact suggestor module 512 may be a Python script which may retrieve contacts starting with the given characters and may enable the showing of a suggestion list for the user when he or she writes in the sender/receiver field in the filtering portion of the mMux page, and the contacts module 514 may be a Python module which offers an API to a Symbian contact database (not shown).

WCD 100 may be running at least Mobile Web Server 504 which is a Symbian port of the Apache httpd web server. In the exemplary embodiment shown in FIG. 2, a user may activate web browser 500 on remote terminal 200 to communicate with Mobile Web Server 504 on WCD 100. Web browser 500 may be directed to a webpage using JavaScript and Asynchronous JavaScript Technology and XML (“AJAX”) web technology. Once the user is logged into his or her account, web browser 500 may make an AJAX request to gateway 202 which may forward an HTTP command to WCD 100 where it is delivered to Mobile Web Server 504. Alternatively, in the case where WCD 100 is not behind a NAT/Firewall, web browser 500 may transmit a request or command directly to WCD 100. In response to the HTTP command, Mobile Web Server 504 may return a response in the form of XML data. It should be noted that in the exemplary embodiment, the operation of gateway 202 is transparent to the user. In other words, from the perspective of the user, it would seem that there is a direct connection between web browser 500 on remote terminal 200 and Mobile Web Server 504 on WCD 100.

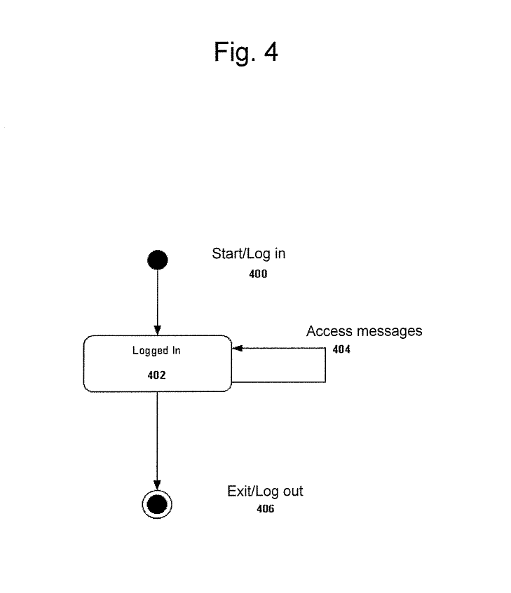

FIG. 4 discloses an exemplary state chart of the steps carried out in accordance with at least one embodiment of the present invention. Upon startup in step 400, web browser 500 may establish a connection to Mobile Web Server 504, logging in the user to his or her wireless account. Next, web browser 500 may enter a logged-in state 402, ready to access messages over the connection established with Mobile Web Server 504. In step 404, upon accessing the messages, web browser 500 may display the messages in a threaded fashion. That is, messages belonging to the same conversation, regardless of the communication channel they were sent/received on, may be organized and displayed as part of a single conversational thread. Using web browser 500, the user may filter or search the messages according to various user-selected sort criteria such as sender, receiver, keywords/content, time ranges, etc. Finally, an exit/logout event of shutting down web browser 500 is shown in step 406, wherein the web browser 500 may log out from the wireless account and/or close the connection to Mobile Web Server 404, after which messages will not be viewable using the web browser 500 without again establishing a connection and logging into the Mobile Web Server 504.

It is important to note that the above described examples are not intended to limit the breadth and scope of the invention to the disclosed embodiment, but rather to illustrate the variety of possibilities embodied in accessing messages received over one or more channels such as SMS, MMS, email, IM, Bluetooth™, etc. using a web browser.

Various exemplary operations described herein may, in various exemplary embodiments, be executed by and/or with the help of computers. Further, for example, devices described hereinabove may be and/or may incorporate computers. The phrases “data computing device,” “general purpose computer,” “computer,” “remote terminal,” and the like, as used herein, refer but are not limited to a smart card, a media device, a personal computer, an engineering workstation, a PC, a Macintosh, a PDA, a portable computer, a computerized watch, a wired or wireless terminal, phone, communication device, node, and/or the like, a server, a network access point, a network multicast point, a network device, a set-top box, a personal video recorder (PVR), a game console, a portable game device, a portable audio device, a portable media device, a portable video device, a television, a digital camera, a digital camcorder, a Global Positioning System (GPS) receiver, a wireless personal server or the like, or any combination thereof, perhaps running an operating system such as OS X, Linux, Darwin, Windows CE, Windows XP, Windows Server 2003, Palm OS, Symbian OS, or the like, perhaps employing the Series 40 Platform, Series 60 Platform, Series 80 Platform, and/or Series 90 Platform, and perhaps having support for Java and/or Net.

The phrases “data computing device,” “general purpose computer,” “computer,” “remote terminal,” and the like also refer, but are not limited to, one or more processors operatively connected to one or more memory or storage units, wherein the memory or storage may contain data, algorithms, and/or program code, and the processor or processors may execute the program code and/or manipulate the program code, data, and/or algorithms. Each of I/O interfaces may, for example, be an Ethernet, IEEE 1394, IEEE 1394b, IEEE 802.11a, IEEE 802.11b, IEEE 802.11g, IEEE 802.11i, IEEE 802.11e, IEEE 802.11n, IEEE 802.15a, IEEE 802.16a, IEEE 802.1d, IEEE 802.16e, IEEE 802.16x, IEEE 802.20, IEEE 802.15.3, ZigBee, Bluetooth, Ultra Wide Band (UWB), Wireless Universal Serial Bus (WUSB), wireless Firewire, terrestrial digital video broadcast (DVB-T), satellite digital video broadcast (DVB-S), Advanced Television Systems Committee (ATSC), Integrated Services Digital Broadcasting (ISDB), Digital Multimedia Broadcast-Terrestrial (DMB-T), MediaFLO (Forward Link Only), Terrestrial Digital Multimedia Broadcasting (T-DMB), Digital Audio Broadcast (DAB), Digital Radio Mondiale (DRM), General Packet Radio Service (GPRS), Universal Mobile Telecommunications Service (UMTS), Global System for Mobile Communications (GSM), Code Division Multiple Access 2000 (CDMA2000), DVB-H (Digital Video Broadcasting: Handhelds), IrDA (Infrared Data Association), and/or other interface.

Mass storage may be a hard drive, optical drive, a memory chip, or the like. Processors may each be a commonly known processor such as an IBM or Freescale PowerPC, an AMD Athlon, an AMD Opteron, an Intel ARM, an Intel XScale, a Transmeta Crusoe, a Transmeta Efficeon, an Intel Xenon, an Intel Itanium, an Intel Pentium, or an IBM, Toshiba, or Sony Cell processor. Computer as shown in this example also includes a touch screen and a keyboard. In various exemplary embodiments, a mouse, keypad, and/or interface might alternately or additionally be employed. Computer may additionally include or be attached to card readers, DVD drives, floppy disk drives, hard drives, memory cards, ROM, and/or the like whereby media containing program code (e.g., for performing various operations and/or the like described herein) may be inserted for the purpose of loading the code onto the computer.

In accordance with various exemplary embodiments of the present invention, a computer may run one or more software modules designed to perform one or more of the above-described operations. Such modules might, for example, be programmed using languages such as Java, Objective C, C, C#, C++, Perl, Python, and/or Comega according to methods known in the art. Corresponding program code might be placed on media such as, for example, DVD, CD-ROM, memory card, and/or floppy disk. It is noted that any described division of operations among particular software modules is for purposes of illustration, and that alternate divisions of operation may be employed. Accordingly, any operations discussed as being performed by one software module might instead be performed by a plurality of software modules. Similarly, any operations discussed as being performed by a plurality of modules might instead be performed by a single module. It is noted that operations disclosed as being performed by a particular computer might instead be performed by a plurality of computers. It is further noted that, in various exemplary embodiments, peer-to-peer and/or grid computing techniques may be employed. It is additionally noted that, in various exemplary embodiments, remote communication among software modules may occur. Such remote communication might, for example, involve Simple Object Access Protocol (SOAP), Java Messaging Service (JMS), Remote Method Invocation (RMI), Remote Procedure Call (RPC), sockets, and/or pipes.

It is noted that various operations and/or the like described herein may, in various exemplary embodiments, be implemented in hardware (e.g., via one or more integrated circuits). For instance, in various exemplary embodiments various operations and/or the like described herein may be performed by specialized hardware, and/or otherwise not by one or more general purpose processors. One or more chips and/or chipsets might, in various exemplary embodiments, be employed. In various exemplary embodiments, one or more Application-Specific Integrated Circuits (ASICs) may be employed.

The present invention is described above by using the Global System for Mobile Communication (“GSM”) mobile communication system as an example of the information transmission network system. However, the invention is not limited to this mobile communication system. The invention can also be applied in other mobile communication systems which have the capability for transmitting addressed information. The mobile communication system can be simplex or duplex.

As is known, a GSM mobile communication network consists of mobile services switching centers (“MSC”) and of base station systems (“BSS”). A base station system consists of a base station and a base station controller. Each BSS is controlled by one MSC. MSC's communicate with each other, wherein calls and other signaling can be transmitted within the mobile communication network as well as between the mobile communication network and a landline telecommunication network or another mobile communication network. In the same geographical area, there can also be several mobile communication networks. The MSC has a home location register (“HLR”) and a visitor location register (“VLR”). The HLR is a database of the mobile communication network containing the basic data of the mobile phone subscribers registered in the network. The HLR contains, for example, the international mobile subscriber identity, the mobile subscriber international ISDN number, and data related to the services available to the subscriber. The VLR is a database of the mobile communication network containing the data required of the mobile subscribers within the area of the mobile communication network at each time for the transmission of calls. The visitor location register VLR is used, for example, for the control of the mobility of the mobile phone, wherein calls and messages can be directed to the correct mobile phone, also in a situation where the mobile phone is in the area of a different mobile communication network than in which the mobile phone is registered. This situation comes also for example when the mobile phone is used abroad.

With GSM mobile phones, each mobile subscriber must have at least one subscriber identity module (“SIM”) card. This SIM card contains the identification data of the mobile subscriber, such as the code and telephone number of the mobile subscriber. Thus by using these identification data, the messages and calls can be directed to the correct mobile station. The SIM card can also be moved to another mobile station, if necessary, wherein also the calls are transmitted to this other mobile phone. The use of a SIM card requires usually that a PIN code is entered at the stage when the mobile phone is turned on. This PIN code can be changed by the mobile subscriber, and the code is intended for preventing misuse of the SIM card for example if the SIM card is lost.

Although the description above contains many specifics, these are merely provided to illustrate the invention and should not be construed as limitations of the invention's scope. Thus it will be apparent to those skilled in the art that various modifications and variations can be made in the system and processes of the present invention without departing from the spirit or scope of the invention.

In addition, the exemplary embodiments, features, methods, systems, and details of the invention that are described above in the application may be combined separately or in any combination to create or describe new exemplary embodiments of the invention.

It is noted that the various examples of this exemplary embodiment are not intended to limit the breadth and scope of the invention, but rather to illustrate the variety of possibilities embodied in processing and displaying the notification of remote terminal events to a user.

What is claimed is:

1. A method comprising:
establishing a connection between a wireless communication device and a remote terminal;
accessing from said remote terminal, messages that have been sent or received on said wireless communication device via one or more wireless channels; and
displaying said messages on said remote terminal in one or more conversational threads.

2. The method according to claim 1, wherein the one or more wireless channels include at least SMS, MMS, IM, Bluetooth and email.

3. The method according to claim 1, further comprising:
filtering said messages according to one or more criteria.

4. The method according to claim 1, wherein displaying said messages on said remote terminal in one or more conversational threads includes visually aggregating messages by conversation.

5. The method according to claim 1, wherein accessing said messages includes:
transmitting a request from said remote terminal to a Mobile Web Server residing on said wireless communication device; and
receiving a response at said remote terminal.

6. An apparatus comprising:
at least one wireless communication module; and
a processor coupled to the at least one wireless communication module, wherein the processor is configured to:
establish a wireless connection; and
enable access, over the wireless connection, to messages stored on the apparatus that have been sent or received via one or more wireless channels for organization into one or more conversational threads.

7. The apparatus according to claim 6, wherein said one or more wireless channels include at least SMS, MMS, IM, Bluetooth and email.

8. The apparatus according to claim 6, further configured to transmit and receive data to/from a remote terminal.

9. A computer program product comprising a computer usable medium having computer readable program code embodied in said medium, comprising:
a computer readable program code configured to establish a connection between a wireless communication device and a remote terminal;
a computer readable program code configured to access from said remote terminal, messages that have been sent or received on said wireless communication device via one or more wireless channels; and
a computer readable program code configured to display said messages on said remote terminal in one or more conversational threads.

10. The computer program product of claim 9, wherein said wireless channels include at least SMS, MMS, IM, Bluetooth and email.

11. The computer program product of claim 9, further comprising:
a computer readable program code configured to filter said messages according to one or more criteria.

12. The computer program product of claim 9, wherein displaying said messages on said remote terminal in one or more conversational threads includes visually aggregating messages by conversation.

13. The computer program product of claim 9, wherein accessing said messages includes:
transmitting a request from said remote terminal to a Mobile Web Server residing on said wireless communication device; and
receiving a response at said remote terminal.

14. A system comprising:
a wireless communication device;
a remote terminal, the remote terminal including at least a web browser; and
the wireless communication device configured to establish a connection with said web browser;
the web browser configured to access messages that have been sent or received on said wireless communication device via one or more wireless channels and to display said messages on said remote terminal in one or more conversational threads.

15. An apparatus comprising:
means for establishing a wireless connection;
means for enabling access, over the wireless connection, to messages stored on the apparatus that have been sent or received via one or more wireless channels for organization into one or more conversational threads.

16. The apparatus according to claim 15, wherein the one or more wireless channels include at least SMS, MMS, IM, Bluetooth and email.

17. The apparatus according to claim 15, further configured to transmit and receive data to/from a remote terminal.
